(19) United States
(12) Patent Application Publication
(10) Pub. No.: US 2006/0092136 A1
(43) Pub. Date: May 4, 2006

(54) Track ball device

(76) Inventors: Kenji Nishimura, Osaka (JP); Tamotsu Yamamoto, Hyogo (JP)

Correspondence Address: WENDEROTH, LIND & PONACK L.L.P., 2033 K. STREET, NW, SUITE 800, WASHINGTON, DC, 20006, US

(21) Appl. No.: 11/259,207

(22) Filed: Oct. 27, 2005

(30) Foreign Application Priority Data
Nov. 2, 2004 (JP) 2004-318962

(51) Int. Cl. G09G 5/08

(52) U.S. Cl. 345/167

(57) ABSTRACT

A track ball device includes a ball, a roller rotating according to rotation of the ball, a detector for detecting rotation of the roller, and a switch being activated when being depressed with the ball. The ball is made of polyether urethane resin material having a hardness ranging from JIS K7311 JISA80 to JISA99. The roller is spaced from the ball when the ball is not activated. The switch is activated and generating a click feel when being depressed with the ball. The track ball device provides a clear click feel through the ball from the push switch.

### FIELD OF THE INVENTION

The present invention relates to a track ball device arranged to be used in an input unit of an electronic apparatus.

### BACKGROUND OF THE INVENTION

FIG. 6 is a cross sectional view of a conventional track ball device 1001 disclosed in Japanese Patent Laid-Open Publication No.2002-373055. FIG. 7 is a perspective view of the track ball device 1001. FIG. 8 is an exploded perspective view of the track ball device 1001. FIGS. 9 and 10 are an upper and a side view of the track ball device 1001, respectively.

A mounting base 2 made of resin having a substantially cross shape is provided on a upper case 1 made of resin having a substantially cross shape.

A cover 3 made of metallic sheet is mounted on the upper case 1. The cover 3 includes, as shown in FIGS. 7 and 8, a pair of legs 3A and another pair of legs 3C extending downward from respective edges of four stems of the cross shape of the upper case 1. The legs 3A extend downward from two ends of the cross shape opposite to each other. The legs 3C extend downward from two ends other than the ends with the legs 3A. Each of the legs 3A has a through-hole 3B provided in the distal end thereof. Each of the legs 3C has locking tabs 3D provided on both sides of the lowermost end thereof.

The mounting base 2 has a projection 2A on each side thereof for engagement with the corresponding through-hole 3B of the cover 3. The locking tabs 3D of the legs 3C of the cover 3 are engaged with step portions at the sides of the mounting base 2 as to joint the upper case 1 to the mounting base 2.

The upper case 1 has a pair of hook portions 1A provided on both sides of each stem of the substantially cross shape thereof to form downward opening notches, respectively. Rollers 4A to 4D having substantially cylindrical shapes having rotating axes extend along four sides of a square, respectively. The rotating axes of the rollers 4A and 4C are parallel with each other. The rotating axes of the rollers 4B and 4D are parallel with each other and orthogonal to the rotating axis of the roller 4A. The downwardly opening notches at the hook portions 1A rotatably hold the rollers 4A to 4D as roller journal supporters 1B. The bottom portions of the rollers 4A to 4D are supported by the upper surface of the mounting base 2. Each of the rollers 4A to 4D has a contact portion having a jaggy surface provided at the middle portion thereof.

Each of the rollers 4A to 4D, as shown in FIGS. 7 to 10, has magnets 5A to 5D mounted annularly to one end thereof. The magnets are magnetized to have N poles and P poles alternately at equal angular intervals of 90 degrees and are arranged to rotate together with each of the rollers 4A to 4D. The four rollers 4A to 4D are located so that magnets 5A to 5D accommodated in four corresponding spaces between the stems of the cross shape of the mounting base 2.

A ball 10 made of fluoric rubber is accommodated in an interior space 1D between the upper case 1 and the mounting base 2, and is movable upward and downward.

The mounting base 2 forming the bottom of the interior space 1D has a circular opening 2B provided in the center thereof. A strip spring 6 has one end fixedly mounted to the inner wall at the opening 2B of the base 2 and the other end extending across the circular opening 2B. The other end of the strip spring 6 has a projection 6A projecting downward. The ball 10 is elastically supported by the projection 6A of the strip spring 6.

The upper case 1 has a tubular shape extending upward and forming the interior space 1D at the center. The center opening 1C at the uppermost of the upper case 1 has a diameter slightly smaller than that of the ball 10. This arrangement allows the ball 10 to contact the uppermost at the center opening 1C of the upper case 1 while the ball 10 is urged upward by the strip spring 6, and restricts the upper-going movement of the ball. The top of the ball 10 projects upward from the center opening 1C of the upper case 1. At this stage, the ball 10 is spaced by a predetermined distance from the contact portions of the rollers 4A to 4D.

Upon being depressed by a downward force, the bottom of the ball 10 pushes down the strip spring 6, and as resisting against the yielding force of the leaf spring 6 for up-and-down movement in the interior space 1D between the upper case 1 and the mounting base 2.

A circuit board 15 is provided below the upper case 1, the cover 3, the rollers 4A to 4D, and the mounting base 2. As shown in FIGS. 7 to 10, magnetic sensors 20 are mounted on the circuit board 15. The magnetic sensors 20 face magnets 5A to 5D, respectively. The magnetic sensors 20 detects changes in magnetic field of the magnets 5A to 5D generated by the N and P poles rotating together with the rollers 4A and 4D, thus producing electric signals. That is, the magnets 5A to 5D and the magnetic sensors 20 provide a detector for detecting rotation of the rollers 4A to 4D.

A self-return type push switch 25 is mounted on the circuit board 5 and is surrounded by the magnetic sensors 20 below the ball 10. The push switch 25 generates a click feel when being turned on and off.

The push switch 25 includes a switch contact composed of center fixed contact 26A, outer fixed contact 26B, and a movable contact 27 accommodated in a switch case 25. The movable contact 27 made of thin metallic sheet has a dome shape having a concave surface facing the center fixed contact 26A and spaced by a predetermined gap from the center fixed contact 26A. The circumferential edge of the dome shape is placed on the outer fixed contact 26B. The movable contact 27 generates a click feel when the dome shape is reversed.

An operation of the conventional track ball device 1001 will be explained below. FIGS. 11 and 12 are cross sectional views of the track ball device 1001.

The ball 10 is not activated in a neutral state shown in FIG. 6. The top of the ball 10 projecting upward from the center opening 1C of the upper case 1 is pressed and rotated with a finger or the like in a direction D1 toward the roller 4A. The ball 10 accordingly shifts down and presses the other end of the strip spring 6, as shown in FIG. 11, getting close to the roller 4A. When the ball 10 contacts the contact portion of the roller 4A out of the rollers 4A to 4D corresponding to the rotation direction of the ball 10, the ball 10 causes the roller 4A to rotate. At this moment, the rollers 4B to 4D do not rotate, and the push switch 25 is not activated.

According to the rotation of the roller 4A, the magnet 5A rotates, thus causing N poles and P poles to get close alternately to the magnetic sensor 20. The magnetic sensor 20 detects a change in the magnetic field and produces a predetermined signal accordingly.

Similarly, when the ball 10 is rotated in directions to get close to the rollers 4B to 4D, the magnetic sensors 20 corresponding to the rotation directions of the ball 10 detect changes of magnetic fields, thus producing predetermined signals indicating the movement of the roller, respectively.

When the ball 10 is rotated diagonally, e.g., towards a position between the rollers 4A and 4B, the ball 10 contact both the rollers 4A and 4B and causes the rollers 4A and 4B, and causes the magnets 5A and 5B to rotate accordingly, thus causing the magnetic sensors 20 facing the magnets 5A and 5B to produce predetermined signals simultaneously.

When the top of the ball 10 in the neutral state shown in FIG. 6 is pushed with a finger or the like, the ball 10 presses the other end of the strip spring 6 and moves into the circular opening 2B of the mounting base 2. This movement lowers the projection 6A of the strip spring 6 to allow the projection to reach the movable contact 27 of the push switch 25. When the pressure of the ball 10 for lowering the projection 6A exceeds a predetermined level, the dome shape of the movable contact 27 is reversed, as shown in FIG. 12, thus generating a click feel. As the result, the center fixed contact 26A and the outer fixed contact 26B are electrically connected with each other through the movable contact 27, thus turning on the push switch 25.

Then, when the pressure applied to the ball 10 is cancelled, the movable contact 27 of the push switch 25 returns back to the dome shape by its self-returning strength and electrically disconnects between the center fixed 26A and the outer fixed 26B, thus turning off the push switch 25. Simultaneously, the other end of the strip spring 6 returns back to its original position, thus lifting up the ball 10. The ball 10 accordingly moves into the center opening 1C of and contact the upper case 1, thus returning to the neutral state shown in FIG. 6.

In the conventional track ball device 1001, the ball 10 made of the fluoric rubber is pressed down for activating the push switch 25. If being elastic, the ball 10, the ball 10 absorbs the click feel, which is generated by the push switch 25, due to an elastic deformation of the ball during activation of the switch 25, reducing the click feel upon the activation. The fluoric rubber is expensive and has a narrow range of the selection of its hardness, for example, having a maximum limit of JIS K7311 JISA80. The fluoric rubber is hardly colored and is not light-transmittable, thus having a small visibility.

### SUMMARY OF THE INVENTION

A track ball device includes a ball, a roller rotating according to rotation of the ball, a detector for detecting rotation of the roller, and a switch being activated when being depressed with the ball. The ball is made of polyether urethane resin material having a hardness ranging from JIS K7311 JISA80 to JISA99. The roller is spaced from the ball when the ball is not activated. The switch is activated and generating a click feel when being depressed with the ball.

The track ball device provides a clear click feel through the ball from the push switch.

### BRIEF DESCRIPTION OF THE DRAWINGS

FIG. 1 is a cross sectional view of a track ball device according to an exemplary embodiment of the present invention.

FIG. 2 is a perspective view of the track ball device according to the embodiment.

FIG. 3 is an exploded perspective view of the track ball device according to the embodiment.

FIG. 4 is a cross sectional view of the track ball device according to the embodiment.

FIG. 5 is a cross sectional view of the track ball device according to the embodiment.

FIG. 6 is a cross sectional view of a conventional track ball device.

FIG. 7 is a perspective view of the conventional track ball device.

FIG. 8 is an exploded perspective view of the conventional track ball device.

FIG. 9 is an upper view of the conventional track ball device.

FIG. 10 is a side view of the conventional track ball device.

FIG. 11 is a cross sectional view of the conventional track ball device.

FIG. 12 is a cross sectional view of the conventional track ball device.

### DETAILED DESCRIPTION OF THE PREFERRED EMBODIMENTS

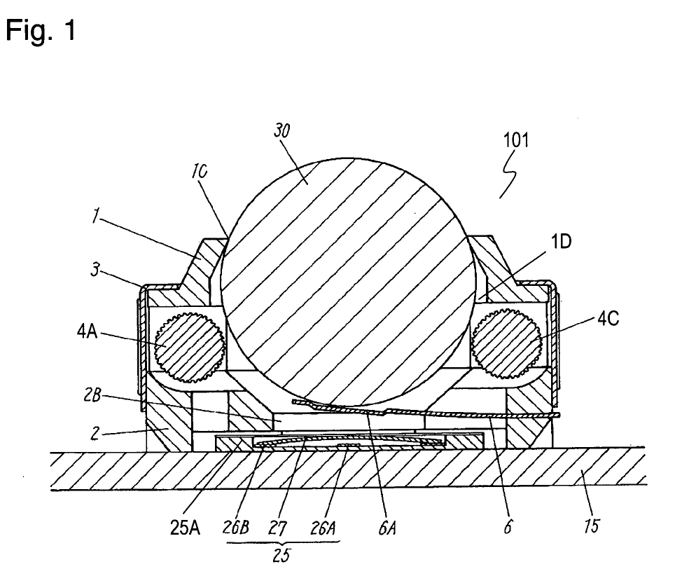

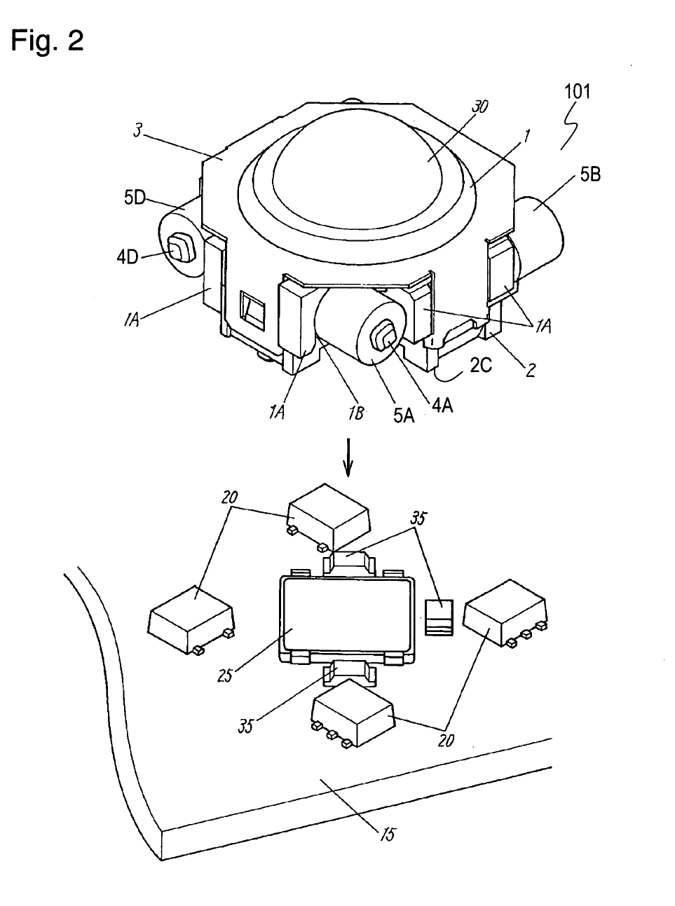

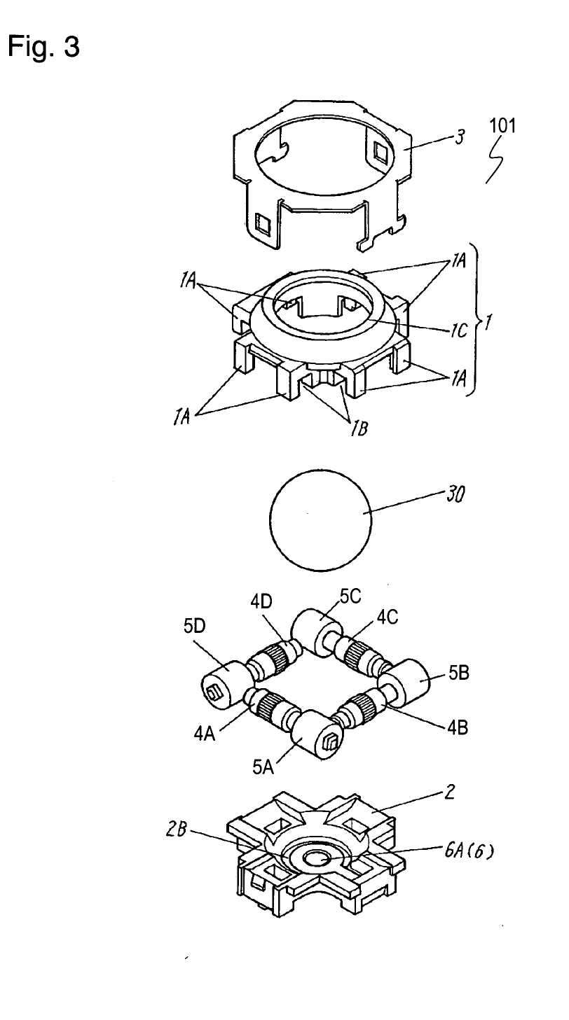

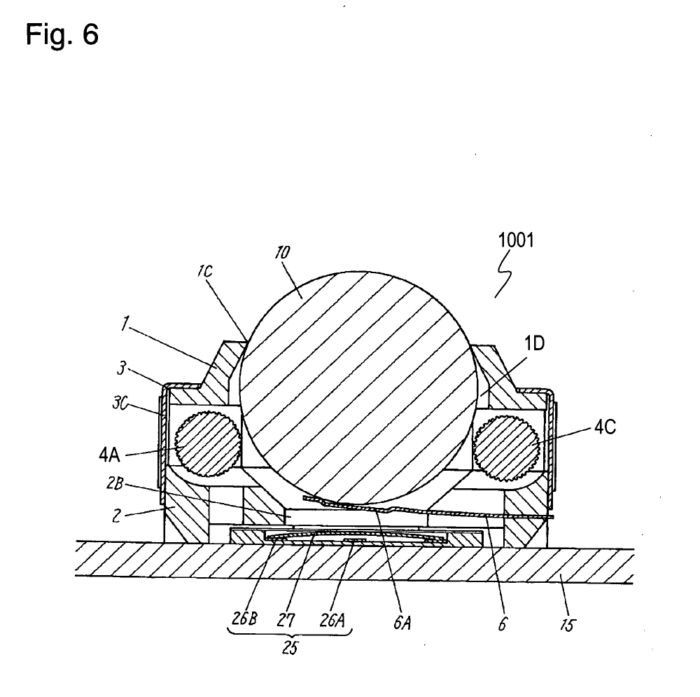

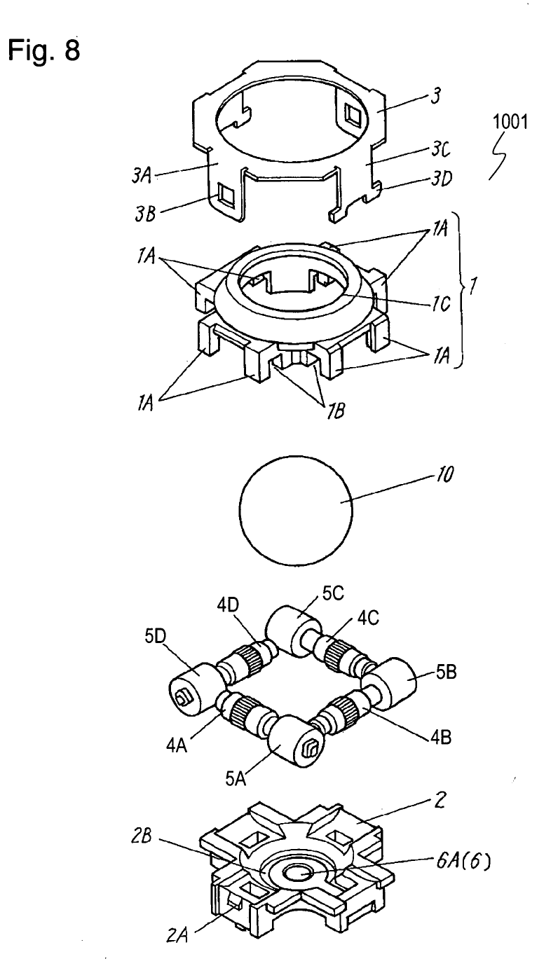

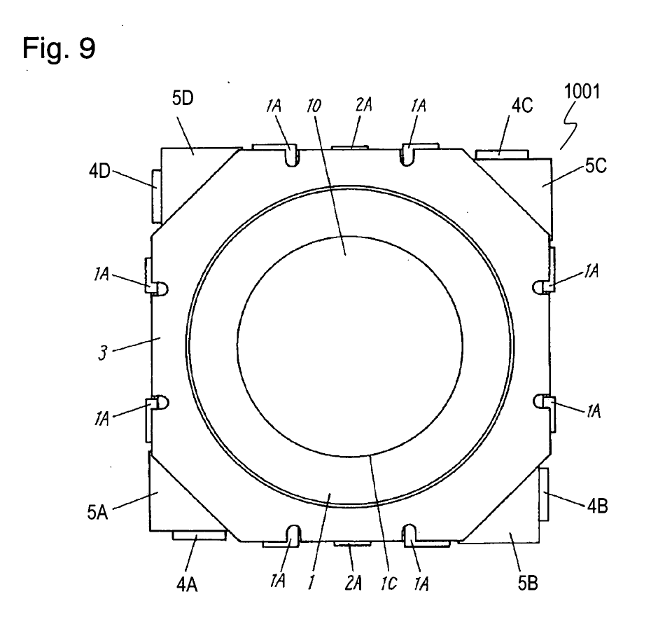

FIG. 1 is a cross sectional view of a track ball device 101 according to an exemplary embodiment of the present invention. FIG. 2 is a perspective view of the track ball device 101. FIG. 3 is an exploded perspective view of the track ball device 101. In the track ball device 101, the same components as those of a conventional track ball device 1001 shown in FIGS. 6-10 are denoted by the same reference numerals, and will be explained in no more detail.

The track ball device 101 includes a ball 30 made of polyether urethane resin material instead of a ball 10 of the conventional track ball 1001. The ball 30 has a hardness ranging from JIS K7311 JISA80 to JISA99, is polished to have a surface roughness ranging from 2 μm to 100 μm, and is light-transmittable. The diameter of the ball 30 is set to 5.5 mm.

The ball 30 is accommodated in an interior space 1D between an upper case 1 and a mounting base 2, and is movable upward and downward. The upper case 1, the mounting base 2, and a cover 3 are identical to those of the conventional track ball device 1001 and are not explained.

Similarly to the conventional track ball device 1001, each of rollers 4A to 4D having a substantially cylindrical shape has magnets 5A to 5D mounted at one end thereof and rotatably held in roller supporters 1B formed by hook portions 1A of the upper case 1. The rollers 4A to 4D are arranged as four sides in a square. A strip spring 6 has one end fixedly mounted to the inner wall at a circular opening 2B of the mount base 2 and has the other end extending across the circular opening 2B. The strip spring 6 has a projection 6A projecting downward at the other end thereof.

The ball 30 is urged upward with the other end of the strip spring 6 in a neutral state, and accordingly contacts the upper end at the center opening 1C of the upper case 1, thereby being restricted from moving upward. The top of the ball 30 projects upward from the center opening 1C. The pressing force of the strip spring 6 for pressing the ball 30 is set to about 0.06 N.

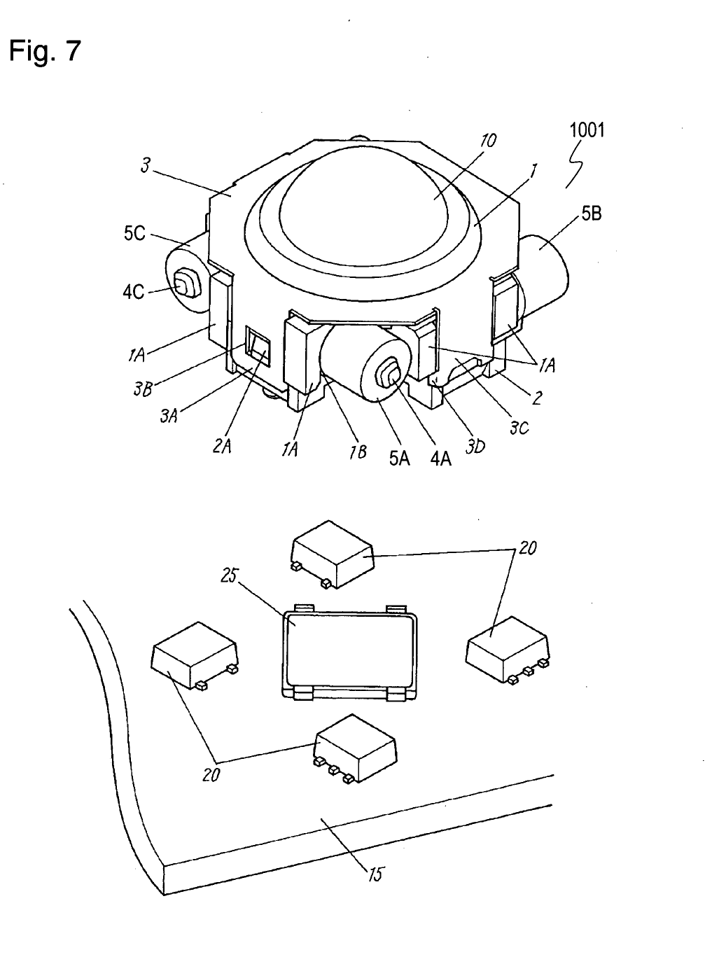

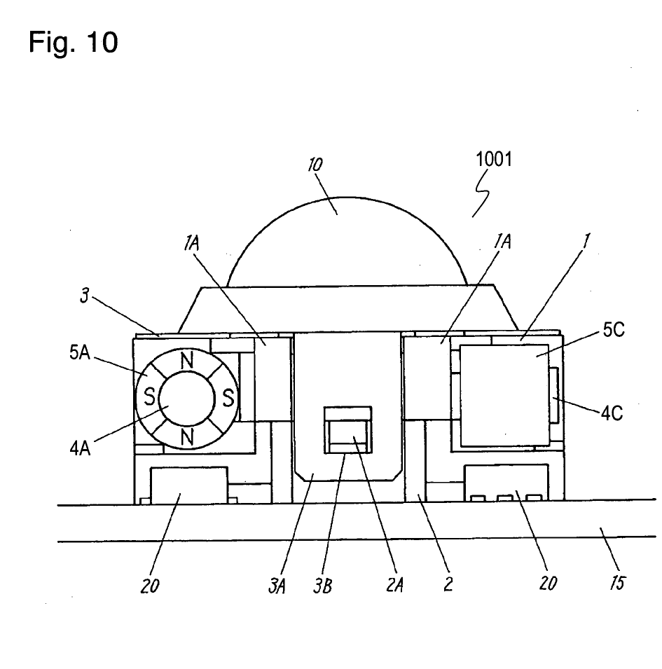

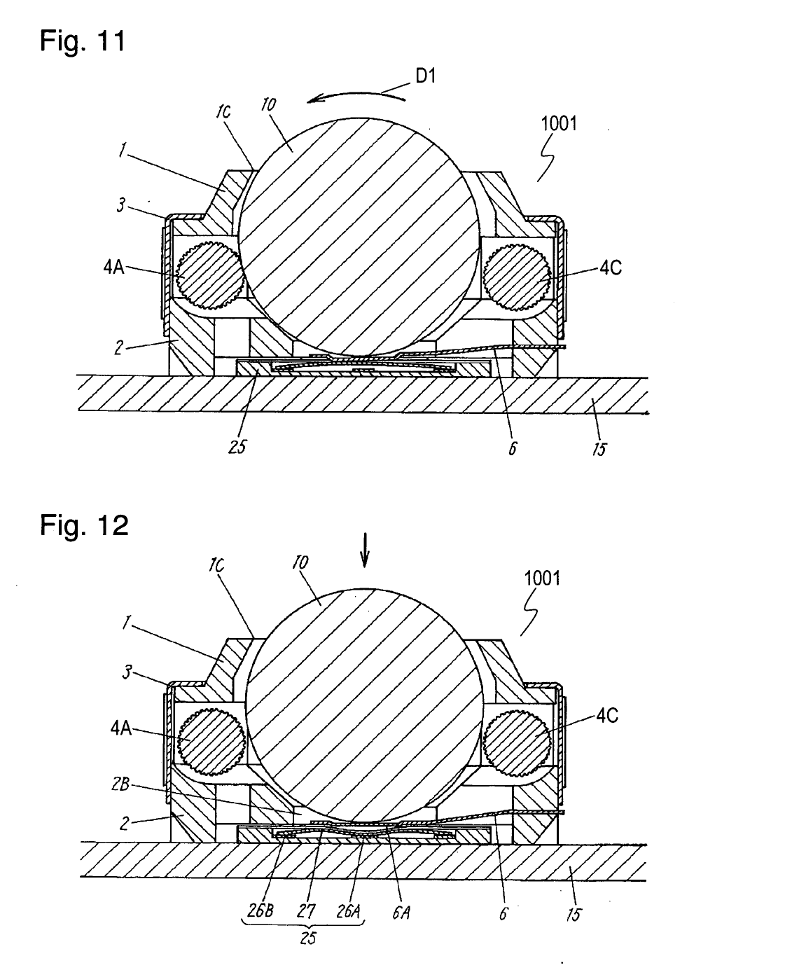

A circuit board 15 is provided below the upper case 1, the cover 3, the rollers 4A to 4D, and the mounting base 2. As shown in FIGS. 7 and 10, magnetic sensors 20 are mounted on the upper surface of the circuit board 15. The magnetic sensor 20 faces magnets 5A to 5D, respectively. The magnetic sensors 20 detect changes of magnetic field of the magnets 5A to 5D which have N and P poles and which rotate together with the rollers 4A and 4D, thus producing predetermined signals. Thus, the magnets 5A to 5D and the magnetic sensors 20 provide a detector for detecting rotation of the rollers 4A to 4D.

A self-return type push switch 25 is mounted on the circuit board 5 and is surrounded by the magnetic sensors 20 below the ball 10. The push switch 25 generates a click feel when being turned on and off.

The push switch 25 includes a switch contact composed of center fixed contact 26A, outer fixed contact 26B, and a movable contact 27 accommodated in a switch case 25. The movable contact 27 made of thin metallic sheet has a dome shape having a concave surface facing the center fixed contact 26A and spaced by a predetermined gap from the center fixed contact 26A. The circumferential edge of the dome shape is placed on the outer fixed contact 26B. Upon receiving a force of 1.6 N, the dome shape of the movable contact 27 is reversed, and generates the click feel.

Light emitters 35, such as light emitting diodes (LEDs) for illuminating the ball 30 are provided between the magnetic sensors 20 and the push switch 25 on the printed circuit board 15.

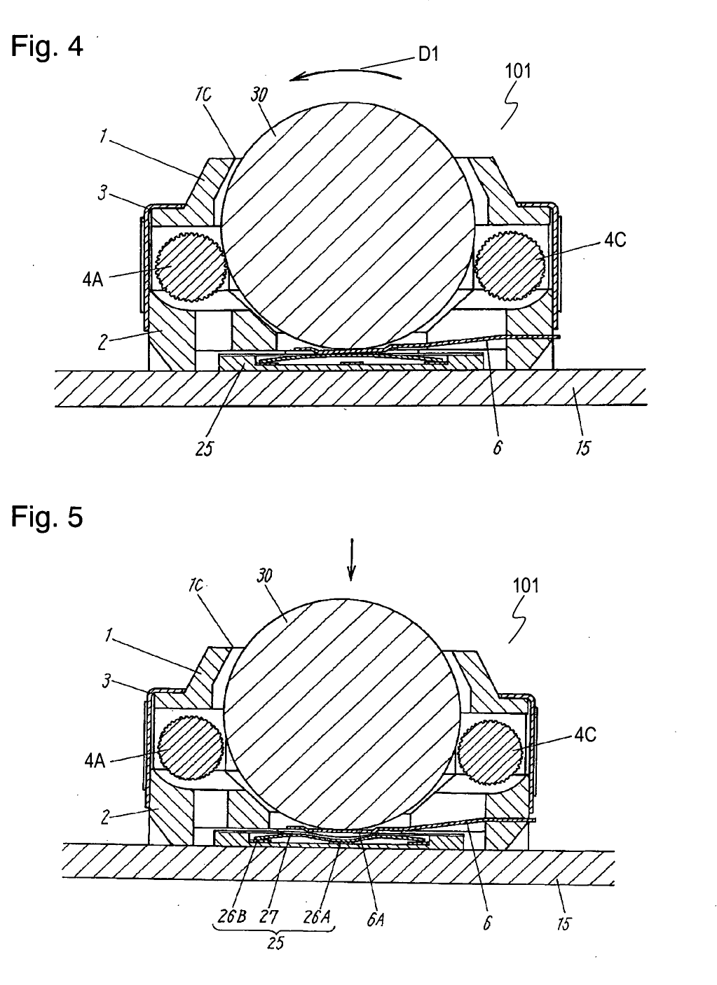

An operation of the track ball device 101 will be explained. FIGS. 4 and 5 are cross sectional views of the track ball device 101.

The ball 30 is not activated in a neutral state shown in FIG. 1. The top of the ball 30 projecting upward from the center opening 1C of the upper case 1 is pressed with a finger or the like in a direction D1 toward the roller 4A. The ball 30 accordingly shifts down and presses the other end of the strip spring 6, as shown in FIG. 4, thus getting close to the roller 4A. When the ball 30 contacts a contact portion of the roller 4A out of the rollers 4A to 4D corresponding to the rotation direction of the ball 30, the ball 30 causes the roller 4A to rotate. The ball 30 has the surface having the roughness ranging from 2 μm to 100 μm, thereby producing a stable friction against the contact portion of the roller 4A. This arrangement allows the roller 4A to rotate securely with the ball 30 without slipping. At this moment, the rollers 4B to 4D do not rotate, and the push switch 25 is not activated The rollers 4A to 4D are spaced from the ball 30 when the ball 30 is in the neutral state, and rotate according to the rotation of the ball 30 only upon contacting the ball 30.

According to the rotation of the roller 4A, the magnet 5A rotates, thus causing N poles and P poles to get close alternately to the magnetic sensor 20. The magnetic sensor 20 detects a change in the magnetic field and produces a predetermined signal accordingly.

Similarly, when the ball 30 is rotated in directions to get close to the rollers 4B to 4D, the magnetic sensors 20 corresponding to the rotation directions of the ball 30 detect changes of magnetic fields, thus producing predetermined signals indicating the movement of the roller, respectively.

When the ball 30 is rotated diagonally, e.g., towards a position between the rollers 4A and 4B, the ball 30 contact both the rollers 4A and 4B and causes the rollers 4A and 4B, and causes the magnets 5A and 5B to rotate accordingly, thus causing the magnetic sensors 20 facing the magnets 5A and 5B to produce predetermined signals simultaneously.

The ball 30 has the surface roughness ranging from 2 μm to 100 μm, and thereby causes the rollers 4A to 4D to rotate stably. If having a surface roughness greater than 100 μm, the ball 30 may not contact the rollers 4A to 4D securely, thus preventing the rotation of the ball from smoothly transmitting to the rollers 4A to 4D, however, this depends on the diameter of the ball 30.

When the top of the ball 30 in the neutral state shown in FIG. 1 is pushed with a finger or the like, the ball 30 presses the other end of the strip spring 6 and moves into the circular opening 2B of the mounting base 2. This movement lowers the projection 6A of the strip spring 6 to allow the projection to reach the movable contact 27 of the push switch 25. When the pressure of the ball 30 for lowering the projection 6A exceeds a predetermined level, the dome shape of the movable contact 27 is reversed, as shown in FIG. 12, thus generating a click feel. As the result, the center fixed contact 26A and the outer fixed contact 26B are electrically connected with each other through the movable contact 27, thus turning on the push switch 25.

The ball 30, having a hardness ranging from JIS K7311 JISA80 to JISA99, deforms less than the conventional ball 10 when pressing the push switch 25, hence hardly absorbing the click feel generated by the push switch 25. The ball 30 accordingly transmits the click feel to a finger or the like of an operator.

Then, when the pressure applied to the ball 30 is cancelled, the movable contact 27 of the push switch 25 returns back to the dome shape by its self-returning strength and electrically disconnects between the center fixed 26A and the outer fixed 26B, thus turning off the push switch 25. Simultaneously, the other end of the strip spring 6 returns back to its original position, thus lifting up the ball 30. The ball 30 accordingly moves into the center opening 1C of and contact the upper case 1, thus returning to the neutral state shown in FIG. 1.

When the light emitters 35 on the circuit board 15 are turned on, light from the light emitters 35 passes through the ball 30 made of the light transmittable polyether urethane resin material, and is recognized. This operation allows functions of the ball 30 to be identified by examining the color of the light from the light emitters 35. For example, each color of the light from the light emitters 35 and a screen of a liquid crystal display in a mobile apparatus including the track ball device 101 may be assigned to one of the functions. This arrangement allows the track ball device 101 to be used as an auxiliary device for activating the apparatus.

The light emitters 35 face the bottom surface 2C of the mounting base 2. The mounting base 2 may be made of material colored in white to transmit the light while the upper case may be made of non-light-transmittable material. This arrangement allows the ball 30 to be illuminated by the light passing through the mounting base 2 and visibly identified clearly.

The ball 30 made of the polyether urethane resin material is easily colored, and can thus visibly be identified inexpensively.

The magnets 5A to 5D and the magnetic sensors 20 provide the detector for measuring the rotation of the rollers 4A to 4D according to the embodiment. The detector may be implemented by encoders or rotation detecting switches. The push switch 25 is not limited to the type disclosed in the embodiment, but may be any switch generating a click feel.

The track ball device 101 according to the embodiment includes four rollers 4A to 4D, however, the number of the rollers is not limited to four Yand may be any number, providing the same effects.

What is claimed is:

1. A track ball device comprising:
a ball made of polyether urethane resin material having a hardness ranging from JIS K7311 JISA80 to JISA99;
a roller spaced from said ball when said ball is not activated, said roller rotating according to rotation of said ball;
a detector for detecting rotation of said roller; and
a switch being activated and generating a click feel when being depressed with said ball.

2. The track ball device according to claim 1, wherein said ball has a surface roughness ranging from 2 μm to 100 μm.

3. The track ball device according to claim 1, wherein said switch is located below said ball, and is activated when depressed down by said ball.

4. The track ball device according to claim 1, wherein said ball is light-transmittable.

5. The track ball device according to claim 1, further comprising a light emitter for emitting light passing through said ball.
